(19) United States
(12) Patent Application Publication
(10) Pub. No.: US 2013/0305920 A1
(43) Pub. Date: Nov. 21, 2013

(54) Preparation of Zeolitic Imidazolate Frameworks (ZIFs) - Polybenzimidazole Mixed-Matrix Composite and Application for Gas and Vapor Separation

(71) Applicants: Tingxu Yang, Singapore (SG); Youchang Xiao, Singapore (SG); Tai-Shung Chung, Singapore (SG)

(72) Inventors: Tingxu Yang, Singapore (SG); Youchang Xiao, Singapore (SG); Tai-Shung Chung, Singapore (SG)

(73) Assignee: NATIONAL UNIVERSITY OF SINGAPORE, Singapore (SG)

(21) Appl. No.: 13/983,907

(22) PCT Filed: Feb. 6, 2012
(86) PCT No.: PCT/SG2012/000032

§ 371 Date: Aug. 6, 2013

Related U.S. Application Data
(60) Provisional application No. 61/442,326, filed on Feb. 14, 2011.

(51) Int. Cl. B01D 53/22

(52) U.S. Cl. CPC B01D 53/228
USPC 95/45; 524/106

(57) ABSTRACT

The present invention presents a mixed-matrix composite material comprising a continuous phase and zeolitic imidazolate framework (ZIF) particles dispersed in the continuous phase, wherein the continuous phase is polybenzimidazole (PBI), methods for making the mixed-matrix composite material, and methods for separating gas or vapor from a mixture of gases or vapors using the mixed-matrix composite material.

### RELATED APPLICATIONS

This application claims the benefit of U.S. Provisional Application No. 61/442,326, filed on Feb. 14, 2011. The entire teachings of the above application are incorporated herein by reference.

### BACKGROUND OF THE INVENTION

Membrane science and technology have been recognized as powerful tools for industrial applications and solving some important global problems. In the recent years, membrane processes for gas and vapor separation are gaining greater acceptance in industry [1]. The efficiency of this technology depends on the selection of membrane materials. Compared to other membranes processes where pore size and pore size distribution are the key factors, such as ultrafiltration or microfiltration, the choice of materials for ultrathin, dense gas and vapor separation membranes is much more demanding [2]. The development of new tough, high performance materials is the key for new applications of gas and vapor separation membranes in challenging and harsh environments.

A few inorganic materials have exhibited exciting selectivity or permeability for gas and vapor separation. Nonetheless, the considerable cost and unsatisfying mechanical property make inorganic membranes not commercially attractive. In addition, the preparation of defect-free layers of these inorganic materials on a large scale is extremely challenging. Currently, the dominating materials for gas and vapor separation membranes are organic polymers, which are easy to process, economical and demonstrate reasonable performance properties. Unfortunately, most of the available polymer materials employed currently can only be used below 150° C. [3] and are not stable in harsh high-temperature environments.

Polybenzimidazole (PBI) has been used for producing gas and vapor separation membranes because it has remarkable resistance to high temperatures (up to 500° C.) [4] with superior mechanical strength [5]. However, PBI exhibits low gas permeability due to the relatively high density chain packing [6]. This material is not suitable for direct gas separation usages at room temperature. Although coating PBI on metal tube supports [7] and spinning PBI into hollow fibers [8] could introduce a thin selective layer with a large surface area and thus improve its gas separation performance, molecular modifications of PBI materials with enhanced intrinsic gas separation performance may be a better approach.

Mixed matrix membranes (MMMs) consisting of polymeric materials and inorganic components have been extensively studied during the last two decades [9-11] since the basic idea was invented by Kulprathipanja et al. [12] about 25 years ago. A progress review has been conducted by Chung et al. [13]. There are still many challenges in preparation of MMMs consisting of polymeric materials and inorganic components, such as interface voids, pore blockage, chain rigidification, the oversize of zeolite nano-particles, their mutual agglomeration, and poor interface with the polymer matrix.

### SUMMARY OF THE INVENTION

The present invention is directed to a mixed-matrix composite material (also referred to herein as mixed-matrix membranes (MMMs)) comprising a continuous phase and zeolitic imidazolate framework (ZIF) particles dispersed in the continuous phase, wherein the continuous phase is polybenzimidazole (PBI).

Also described herein are methods for making the mixed-matrix composite material. In one aspect, the process of forming a mixed-matrix composite material comprises a) providing a polybenzimidazole solution; b) mixing the ZIF particles with a polybenzimidazole solution for a sufficient amount of time to allow the ZIF particles to uniformly disperse in the polybenzimidazole solution; and c) fabricating the solution into a mixed-matrix composite material. In one embodiment, step c) is performed by casting the solution onto a form and allowing the solution to dry, to thereby produce the mixed-matrix composite material. In another embodiment, step c) is performed by a non-solvent induced phase inversion, to thereby produce the mixed-matrix composite material. The mixed-matrix composite material can be cast into any desired membrane configuration such as but not limited to sheets (symmetric or asymmetric), coating layer on a substrate, or hollow fibers.

In another aspect of this method, steps a) and b) are performed and the resulting solution can be stored for later use. In yet another embodiment, the process of forming a mixed-matrix composite material comprises a) providing a polybenzimidazole solution comprising ZIF particles uniformly disperse in the polybenzimidazole solution; and b) fabricating the solution, to thereby produce the mixed-matrix composite material. The fabricating step can be performed as described above.

Also described herein are methods for separating gas or vapor from a mixture of gases or vapors. In one aspect, the process for separating at least one gas or vapor from a mixture of gases or vapors comprises: a) providing a mixed-matrix composite material of the invention; and b) bringing a mixture of gases or vapors under pressure into contact with the mixed-matrix composite material of step a), whereby one of the gases and vapor permeates the membrane preferentially with respect to at least one other gas or vapor in the mixture of gases or vapors, thereby separating the gas or the vapor from the mixture.

The mixed-matrix composite materials of the invention have demonstrated a uniform ZIFs particle distribution in the PBI polymer phase and enhanced separation performance. These mixed-matrix composite materials show excellent transparency, proper flexibility, boosted separation performance and efficient gas and vapor mixtures separation at elevated temperatures up to about 400° C.

### BRIEF DESCRIPTION OF THE DRAWINGS

FIGS. 1A and 1B show FTIR spectra of ZIF-7/PBI mixed-matrix composite membranes. (1) pure PBI; (2) 10/90 (w/w) ZIF-7/PBI; (3) 25/75 (w/w) ZIF-7/PBI; (4) 50/50 (w/w) ZIF-7/PBI; (5) ZIF-7 powder. FIG. 1A shows FTIR spectra in the original range and FIG. 1B shows spectra in the N—H region.

FIG. 2 shows XRD spectra of ZIF-7/PBI mixed-matrix composite membranes. (1) pure PBI; (2) 10/90 (w/w) ZIF-7/PBI; (3) 25/75 (w/w) ZIF-7/PBI; (4) 50/50 (w/w) ZIF-7/PBI; (5) ZIF-7 (theoretical).

FIG. 3 shows TGA thermograms of ZIF-7/PBI mixed-matrix composite membranes under air atmosphere. (1) pure PBI; (2) 10/90 (w/w) ZIF-7/PBI; (3) 25/75 (w/w) ZIF-7/PBI; (4) 50/50 (w/w) ZIF-7/PBI; (5) ZIF-7 powder.

FIG. 4 shows H₂/CO₂ separation performance of pure PBI and ZIF-7/PBI mixed-matrix composite membranes compared to the Robeson upper bound. Robeson 2008 [21] and Robeson 1994 [22].

FIG. 5 shows XRD spectra of ZIF-8/PBI mixed-matrix composite material.

FIGS. 6A-6C show H₂/CO₂ (50/50) mixed gas separation performance of ZIF-8/PBI based dual-layer hollow fibers from ambient to high temperatures.

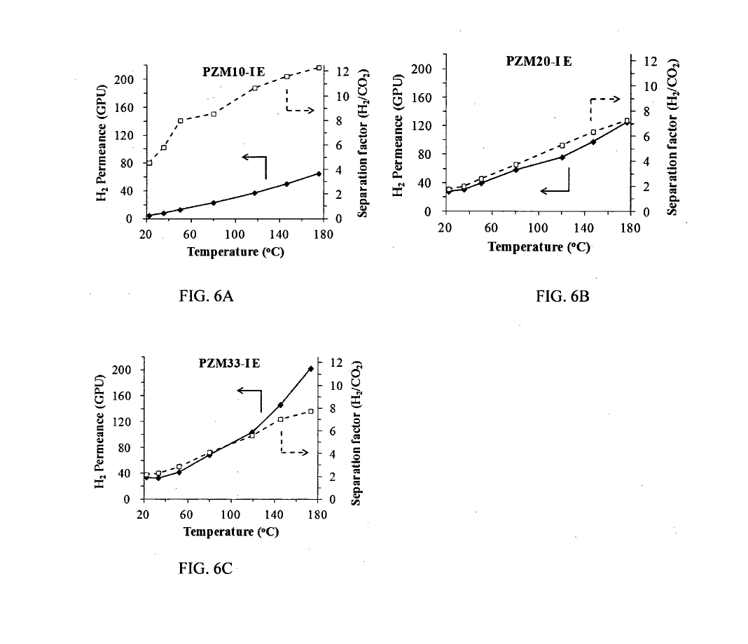

### DETAILED DESCRIPTION OF THE INVENTION

In this invention, novel mixed-matrix composite materials comprising nano-sized zeolitic imidazolate frameworks (ZIFs) particles and polybenzimidazole (PBI) with high thermal stability have been prepared. The resultant composite materials comprise ZIF particles that are uniformly distributed throughout a continuous PBI polymer phase. These mixed-matrix composite materials show excellent transparency, proper flexibility, boosted separation performance and efficient gas and vapor mixtures separation at elevated temperatures up to about 400° C. These properties make the mixed-matrix composite materials of this invention suitable for gas and vapor separation, including but not limited to, hydrogen recovery, air separation, CO₂ separation, separation and recovery of organics from gas streams, air and natural gas dehydration, in a wide range of operating temperatures. Gases that are suitable for use with the invention include, but are not limited to, H₂, He, CO₂, O₂, N₂, CH₄, CO, H₂O, C₂H₄, C₂H₆, C₃H₆, C₃H₈, H₂S, etc.

While not wishing to be bound by theory, it is believed that this uniform distribution of ZIF particles within the continuous phase of the PBI polymer is achieved by incorporating ZIF particles that are wetted, rather than dried. It is believed that wetted ZIF particles can avoid strong interactions with each other, and thus can be distributed within the PBI phase with reduced or no agglomeration. According to one aspect of the invention, methods are described herein to synthesize ZIF particles that are sufficiently wetted with a suitable solvent for incorporation into the PBI polymer phase. Accordingly, the ZIF particles of this invention can achieve a better interaction with the polymer matrix, which will favor a homogeneous distribution, less non-selective voids, and more interaction surface area between polymer matrix and particles.

ZIFs are a family of metal-organic materials that exhibit high porosity with exactly tailorable cavity sizes together with exceptional chemical and thermal stability [14]. The ZIF crystal structures are based on the nets of seven distinct aluminosilicate zeolites: tetrahedral Si(Al) and the bridging O are replaced with transition metal ion and imidazolate link, respectively. Some supported molecular sieve membrane grown from pure ZIFs has shown high fluxes and good selectivity [15, 16]. Like zeolites and other porous materials, ZIFs can be used for the separation of gases because of its highly porous structure, large accessible pore volume with fully exposed edges and faces of the organic links, pore apertures in the range of the kinetic diameter of several gas molecules, and high CO₂ adsorption capacity.

The nano-particle materials of this invention are zeolitic imidazolate frameworks (ZIFs) with metal building units (M), where the metals are selected from the transition metals. In one aspect, the metals are the transition metals selected from zinc (Zn), cobalt (Co), cadmium (Cd), indium (In), iron (Fe), copper (Cu) and combinations thereof. The term “transition metal source”, as used herein, is intended to mean a compound that can provide a transition metal ion, e.g., different salts of the transition metal. Any compound that can provide a transition metal ion can be used, such as M(NO₃)₂.6H₂O, M(NO₃)₂.4H₂O, M(NO₃)₂, M(Cl)₂, M(CH₃COO)₂, where M is a transition metal. The transition metals are bridged by an imidazolate as shown below:

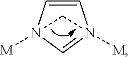

where M is zinc (Zn), cobalt (Co), cadmium (Cd), indium (In), iron (Fe), copper (Cu) or combinations of these.

The examples of the imidazolates suitable for use in the invention include, but are not limited to, the following:

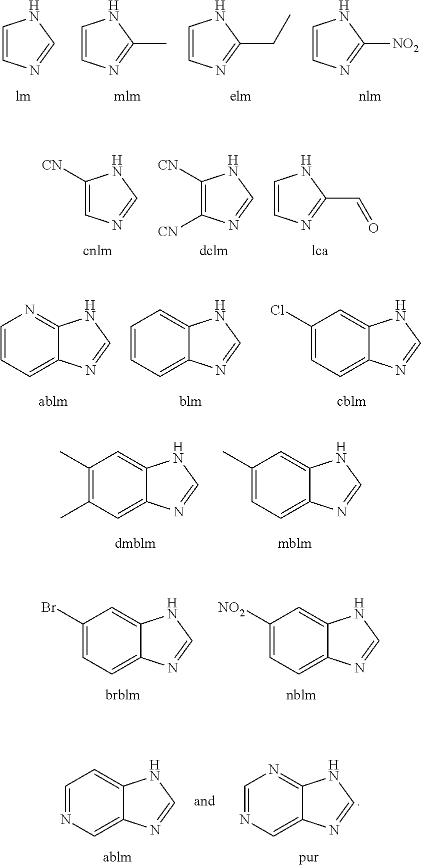

In one aspect, the continuous phase polybenzimidazole (PBI) that is used in the ZIFs/PBI mixed-matrix composite materials of the invention comprises one or more polymers selected from:

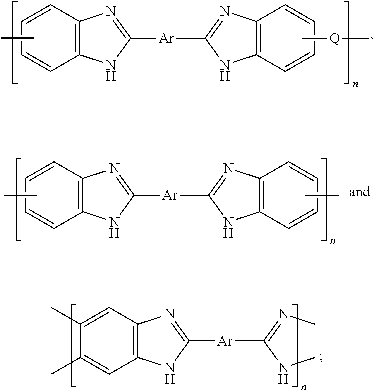

wherein
Ar is an aromatic group selected from a substituted or unsubstituted divalent C6 to C24 arylene group and a substituted or unsubstituted divalent C4 to C24 heterocyclic group; where the aromatic group is present singularly, at least two aromatic groups are fused to form a condensed cycle, or at least two aromatic groups are linked by a single bond or a functional group selected from O, S, C(═O), CH(OH), S(═O)₂, Si(CH₃)₂, (CH₂)ₚ, (CF₂)_{q}, C(CH₃)₂, C(CF₃)₂ and C(═O)NH; p is 1-10; q is 1-10; Q is O, S, C(═O), CH(OH), S(═O)₂, Si(CH₃)₂, (CH₂)ₚ, (CF₂)_{q}, C(CH₃)₂, C(CF₃)₂, C(═O)NH, C(CH₃)(CF₃), or a substituted or unsubstituted phenylene group, wherein the substituted phenylene group is a phenylene group substituted with a C1 to C6 alkyl group or a C1 to C6 haloalkyl group; and further wherein Q is linked with aromatic groups with meta-meta, meta-para, para-meta, or para-para positions; and n is an integer ranging from 10 to 2000; preferably n is 50 to 1000; most preferably n is 100 to 500.

In one aspect of the invention, the one or more polymers of the continuous phase polybenzimidazole is/are selected from:
poly-2,2′-(m-phenylene)-5,5′-bibenzimidazole;
poly-2,2′-(pyridylene-3″,5″)-5,5′-bibenzimidazole;
poly-2,2′-(furylene-2″,5″)-5,5′-bibenzimidazole;
poly-2,2-(naphthalene-1″,6″)-5,5′-bibenzimidazole;
poly-2,2′-(biphenylene-4″,4″)-5,5′-bibenzimidazole;
poly-2,2′-amylene-5,5′-bibenzimidazole;
poly-2,2′-octamethylene-5,5′-bibenzimidazole;
poly-2,6-(m-phenylene)-diimidazobenzene;
poly-2,2′-cyclohexenyl-5,5′-bibenzimidazole;
poly-2,2′-(m-phenylene)-5,5′di(benzimidazole)ether;
poly-2,2′-(m-phenylene)-5,5′-di(benzimidazole)sulfide;
poly-2,2′-(m-phenylene)-5,5′-di(benzimidazole)sulfone;
poly-2,2′-(m-phenylene)-5,5′-di(benzimidazole)methane;
poly-2′-2″-(m-phenylene)-5′,5″(di(benzimidazole)propane-2,2; and
poly-2′,2″-(m-phenylene)-5′,5″-(di(benzimidazole)ethylene-1,2; and further wherein the double bonds of the ethylene are intact in the final polymer.

In one aspect of the invention, a representative mixed-matrix composite material is depicted by Formula (I), using poly-2,2′-(m-phenylene)-5,5′ bibenzimidizole as the polybenzimidizole:

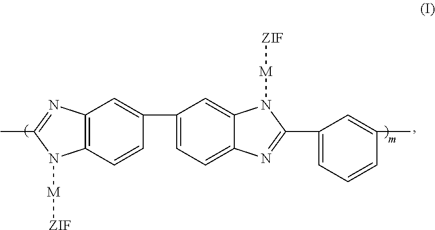

### Wherein:

M is zinc (Zn), cobalt (Co), cadmium (Cd), indium (In), iron (Fe), copper (Cu) or combinations thereof;
m is an integer ranging from 10 to 2000; preferably 50 to 1000; and more preferably 100 to 500; and
ZIF is a zeolitic imidazolate framework particle. For example, ZIF can be Zn(bIm)₂ (referred to herein as ZIF-7) or Zn(mIm)₂ (referred to herein as ZIF-8); where bIm and mIm are described above. Other commercially available or reported ZIF particles can be used in the mixed-matrix composite materials and methods of the invention.

The mixed-matrix composite materials of the invention are made by a process that comprises a) providing a polybenzimidazole solution; b) mixing the polybenzimidazole solution with ZIF particles for a sufficient amount of time to allow the ZIF particles to uniformly disperse in the polybenzimidazole solution; and c) fabricating the solution to thereby produce the mixed-matrix composite material. It is shown by analytic methods described below, that ZIF particles are coupled with PBI containing reactive hydrogen atoms on PBI polymer chains which can react with ZIF during drying of mixed-matrix materials, as described in details below.

The mixed-matrix composite material can be fabricated into a flat sheet (e.g., symmetric or asymmetric), coating layer on a substrate, or hollow fiber. For example, the flat sheet membrane can have both non-porous selective layer and porous supporting layer, or the flat sheet can have two or more layers formed by polymers with different chemical structures. In another example, hollow fibers can be fibers with a hollow lumen wherein two or more components can permeate from its shell side to lumen side (and vice versa) with different permeation rates, so that separation of the components can be achieved.

Membranes of the invention are manufactured by the methods described below, which are not intended to be limiting in any way. Prior to use, the polybenzimidazole material should be sufficiently dried, e.g., overnight at 120° C. under vacuum. Thereafter, a PBI polymer solution is prepared by dissolving polybenzimidazole powder in a solvent. A suitable solvent is one that can dissolve the polymer, such as but not limited to Dimethylacetamide (DMAc), N-Methyl-2-pyrrolidone (NMP), Dimethyl sulfoxide (DMSO), etc. The solvent and concentration will depend upon the type of PBI used and can readily be ascertained. Preferably, the concentration of PBI will be from about 0.5 weight percent to 30 about weight percent. In the example provided herein, a 2% by weight concentration was used. The weight percent of PBI can vary depending upon the end use or membrane configuration. For symmetric sheet membranes cast from thermally drying, the weight percent can be any range once the polymer can be dissolved in the solvent. For coating layer, it is preferred to be low weight percent (for example, from about 0.5% to about 10%). For asymmetric sheet membranes made from non-solvent phase inversion and hollow fibers, it is preferred to be high weight percent (for example, from about 10% to about 30%).

The polymer solution is optionally filtered to remove any undissolved PBI powder and then ZIF particles are mixed into the polymer solution for a period of time sufficient for the ZIF particles to form a uniformly distributed suspension. The ZIF particle size can range from about 5 to about 10000 nm, preferably from about 5 to about 1000 nm, and most preferably from about 5 to about 200 nm. The loading ratio of the ZIF particles will depend upon the end use and desired properties. For example, higher loading may lead to higher gas permeability, higher or lower selectivity; but lower mechanical flexibility. A suitable loading weight percent for ZIF particles in the PBI is from about 1 percent to about 70 percent by weight, and preferably from about 10 percent to about 60 percent by weight. In one embodiment, the ZIF particles loaded into the PBI solution are the same. In another embodiment, two or more different type of ZIF particles can be added to the PBI solution. In one embodiment, the ZIF particles are added to the PBI solution immediately upon their synthesis. In another embodiment, the ZIF particles can be added to the PBI solution after they have been stored in a wet state for a period of time. In either case, the ZIF particles should be kept wetted with suitable solvent before they are incorporated in the PBI polymer phase, to aid, in their uniform distribution within the PBI polymer phase. In one embodiment, the PBI/ZIF solution can be fabricated into the mixed-matrix composite material contemporaneous with formation of the PBI/ZIF suspension. In another embodiment, the PBI/ZIF solution can be fabricated into the mixed-matrix composite material after it has been stored for a period of time.

The PBI/ZIF suspension can be cast onto a form having a desired shape or configuration depending upon the intended end use. For example, films can be made by casting the suspension onto a substrate, such as a silicon wafer plate whose surface will allow easy release of the film when the drying step is completed. The solvent is allowed to evaporate, preferably by a controlled rate of evaporation. The drying can be performed at room temperature or elevated temperature, e.g., from about 20° C. to about 100° C. During this drying step, the PBI/ZIF mixed-matrix composite is formed. After controlled evaporation, the films can be further dried under in vacuum at higher temperature, e.g., from about 60° C. to about 300° C., to remove any residual solvent. The membranes are subsequently solvent-exchanged with methanol and dried in vacuum to remove the residue solvent in ZIF pores.

In another example, the suspension is cast in the form of hollow fibers. The hollow fibers can be fabricated by a non-solvent induced phase inversion method. Dual layer hollow fiber is preferred because PBI itself is brittle from non-solvent induced phase inversion. For dual layer hollow fiber spinning, the inner layer dope and outer layer dope are co-extruded together through a triple-orifice spinneret by a dry-jet/wet spinning process. The detailed description of the set up for dual-layer hollow fiber spinning and process can be found elsewhere [23]. The outer dope is the ZIF/PBI nano-composite material solution (polymer concentration: 15%-30%, particle weight percent: 0-50%). The inner dope is for making a supporting layer, and is made from polymer with proper mechanical strength (strong, and flexible), thermal stability (can well stand the operating temperature), good miscibility with PBI, and low gas permeation resistance. Examples for polymer used in inner dope are P84, Matrimid™, Torlon™, and other high performance polyimides.

In one aspect of the invention, the ZIF particles are formed by: a) mixing a transition metal source and an imidazolate compound in a solvent for a sufficient amount of time to allow the transition metal to link to the imidazolate compound, thereby forming a suspension comprising zeolitic imidazolate framework (ZIF) particles. Suitable solvents will be polar solvents that are non-protic or low-protic, such as but not limited to methanol, water, dimethylformamide (DMF) and N-Methyl-2-pyrrolidone (NMP). Typically, the mixing step is performed at room temperature, e.g., from about 15° C. to about 30° C., using a direct mixing method. Alternatively, they can be also synthesized at low temperature (e.g., from about −40° C. to about 15° C.) or elevated temperature (e.g., from about 30° C. to about 120° C.), depending on properties of particular ZIF and particle size required. “Direct mixing method” is intended herein to mean a method of mixing ZIF monomers (transitional metal such as zinc source and imidazolate compound) and solvent, without adding other agents to induce the reaction. The ZIF particles formed in step a) are collected (e.g., by centrifugation or precipitation and filtration if the particles are of sufficient size (e.g., less than about 200 nm)) and washed with a solvent suitable to wet the ZIF particles. The ZIF particles can then be directly added to the PBI solution or they can be stored in the wet state for a period of time prior to use. The solvents used in steps a) and b) can be the same or different. For step a), the solvent should not prevent ZIF particle formation. For step b), the solvent should not precipitate PBI or cause ZIF particle agglomeration. If the above requirements are met, the solvents in these two steps can be either the same or different. For example, step a) can be performed using DMF, water, methanol and step b) can be performed using NMP, DMAc.

An unprecedented dispersed phase/continuous phase weight ratio as high as 50:50 has been achieved in this invention. In this ratio, the resultant membrane was transparent without any visible agglomeration, and the enhancement on selectivity is kept as well. The ZIFs/PBI mixed-matrix composite materials are also stable at high temperatures (up to about 400° C.) in air due to the excellent thermo stabilities of both PBI and ZIFs. In a mixed gas test from ambient to high temperatures, the membranes demonstrated good properties under realistic operating conditions. Furthermore, the ability to uniformly disperse the nano-size particles within the continuous phase of the polymer allows the material to be easily fabricated into defect-free sheet, asymmetric membranes, hollow fibers and thin layers coating on certain supports, making it more flexible and applicable in industrial solutions. The skilled person would know how to form the materials into desired configurations, depending upon the intended end use and the gas or vapor to be separated.

The mixed-matrix composite materials of the invention are suitable for gas or vapor separation. In one aspect, the mixed-matrix composite material is used for air separation (e.g., separation of nitrogen or oxygen out of air), separation of hydrogen from gases (e.g., nitrogen and methane, CO₂ and CO, H₂O), CO₂ separation from natural gas and nitrogen, or separation of organics from gas streams (e.g., methane from the other components of biogas). In one aspect of the invention, the mixed-matrix composite material is used for gas or vapor recovery. In one aspect, the mixed-matrix composite material is used for hydrogen recovery (e.g., recovery of hydrogen from product streams of ammonia plants or in oil refinery processes) or recovery of organics from gas streams. In another aspect of the invention, the mixed-matrix composite material is used for air, synthetic gas and natural gas dehydration.

### DEFINITIONS

“Alkyl” means a saturated aliphatic branched or straight-chain monovalent hydrocarbon radical having the specified number of carbon atoms. Thus, “(C₁-C₆) alkyl” means a radical having from 1-6 carbon atoms in a linear or branched arrangement. “(C₁-C₆)alkyl” includes methyl, ethyl, propyl, butyl, pentyl and hexyl.

“Alkylene” means a saturated aliphatic straight-chain divalent hydrocarbon radical having the specified number of carbon atoms. Thus, “(C₁-C₆)alkylene” means a divalent saturated aliphatic radical having from 1-6 carbon atoms in a linear arrangement. “(C₁-C₆)alkylene” includes methylene, ethylene, propylene, butylene, pentylene and hexylene.

“Heterocycle” means a saturated or partially unsaturated (4-7 membered) monocyclic heterocyclic ring containing one nitrogen atom and optionally 1 additional heteroatom independently selected from N, O or S. When one heteroatom is S, it can be optionally mono- or di-oxygenated (i.e., —S(O)— or —S(O)₂—). Examples of monocyclic heterocycle include, but not limited to, azetidine, pyrrolidine, piperidine, piperazine, hexahydropyrimidine, tetrahydrofuran, tetrahydropyran, morpholine, thiomorpholine, thiomorpholine 1,1-dioxide, tetrahydro-2H-1,2-thiazine, tetrahydro-2H-1,2-thiazine 1,1-dioxide, isothiazolidine, or isothiazolidine 1,1-dioxide.

“Cycloalkyl” means saturated aliphatic cyclic hydrocarbon ring. Thus, “C₃-C₇cycloalkyl” means (3-7 membered) saturated aliphatic cyclic hydrocarbon ring. C₃-C₇ cycloalkyl includes, but is not limited to cyclopropyl, cyclobutyl, cyclopentyl, cyclohexyl and cycloheptyl.

Haloalkyl and halocycloalkyl include mono, poly, and perhaloalkyl groups where each halogen is independently selected from fluorine, chlorine, and bromine.

“Hetero” refers to the replacement of at least one carbon atom member in a ring system with at least one heteroatom selected from N, S, and O. A hetero ring system may have 1 or 2 carbon atom members replaced by a heteroatom.

“Halogen” and “halo” are interchangeably used herein and each refers to fluorine, chlorine, bromine, or iodine.

The terms “haloalkyl” and “haloalkoxy” mean alkyl or alkoxy, as the case may be, substituted with one or more halogen atoms. The term “halogen” means F, Cl, Br or I. Preferably the halogen in a haloalkyl or haloalkoxy is F.

The term “acyl group” means —C(O)B*, wherein B* is an optionally substituted alkyl group or aryl group (e.g., optionally substituted phenyl).

An “alkylene group” is represented by —[CH₂]_{z}—, wherein z is a positive integer, preferably from one to eight, more preferably from one to four.

An “alkenylene group” is an alkylene in which at least a pair of adjacent methylenes are replaced with —CH═CH—.

The term “(C6-C24)aryl” used alone or as part of a larger moiety as in “arylalkyl”, “arylalkoxy”, or “aryloxyalkyl”, means carbocyclic aromatic rings. The term “carbocyclic aromatic group” may be used interchangeably with the terms “aryl”, “aryl ring” “carbocyclic aromatic ring”, “aryl group” and “carbocyclic aromatic group”. A “substituted aryl group” is substituted at any one or more substitutable ring atom. The term “C₆₋₂₄ aryl” as used herein means a monocyclic, bicyclic or tricyclic carbocyclic ring system containing from 6 to 24 carbon atoms and includes phenyl (Ph), naphthyl, anthracenyl, 1,2-dihydronaphthyl, 1,2,3,4-tetrahydronaphthyl, fluorenyl, indanyl, indenyl and the like.

The term “arylene” means a bivalent radical derived from an aryl by removal of a hydrogen atom from each of two carbon atoms (e.g., phenylene).

The term “heteroaryl”, “heteroaromatic”, “heteroaryl ring”, “heteroaryl group” and “heteroaromatic group”, used alone or as part of a larger moiety as in “heteroarylalkyl” or “heteroarylalkoxy”, refers to aromatic ring groups having five to fourteen ring atoms selected from carbon and at least one (typically 1-4, more typically 1 or 2) heteroatoms (e.g., oxygen, nitrogen or sulfur). They include monocyclic rings and polycyclic rings in which a monocyclic heteroaromatic ring is fused to one or more other carbocyclic aromatic or heteroaromatic rings. The term “5-14 membered heteroaryl” as used herein means a monocyclic, bicyclic or tricyclic ring system containing one or two aromatic rings and from 5 to 14 atoms of which, unless otherwise specified, one, two, three, four or five are heteroatoms independently selected from N, NH, N(C₁₋₆alkyl), O and S.

The term “Alkenyl” means a straight or branched hydrocarbon radical having a specified number of carbon atoms and includes at least one double bond. The (C₆-C₁₀)aryl(C₂-C₆)alkenyl group connects to the remainder of the molecule through the (C₂-C₆)alkenyl portion of (C₆-C₁₀)aryl(C₂-C₆)alkenyl.

Some abbreviations that may appear in this application are as follows.

### Abbreviations

Im imidazole
mIm 2-methyl-imidazole
elm 2-ethyl-imidazole
nIm 2-nitro-imidazole
cnIm 5-isocyano-imidazole
dclm 4,5-dichloro-imidazole
IcIm imidazole-2-carbaldehyde
abIm imidazo[4,5-b]pyridine
bIm benzo[d]imidazole
cbIm 6-chloro-benzo[d]imidazole
dmbIm 5,6-dimethyl-benzo[d]imidazole
mbIm 6-methyl-benzo[d]imidazole
brbIm 6-bromo-benzo[d]imidazole
nbIm 6-nitro-benzo[d]imidazole
abIm imidazo[4,5-c]pyridine
pur purine

### EXAMPLES

### Example 1

### Synthesis of ZIF-7/poly-2,2′-(m-phenylene)-5,5′bibenzimidazole

ZIF-7/poly-2,2′-(m-phenylene)-5,5′ bibenzimidazole is used as a model ZIFs/PBI mixed-matrix composite and is shown below.

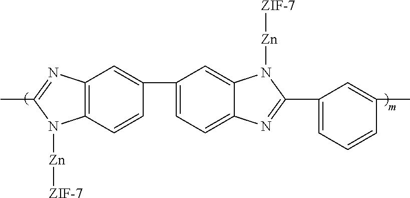

ZIF-7 is used as a model ZIF in this example. In summary, 200 ml dimethylformamide (DMF) was added in a solid mixture of 0.64 g Zn (NO₃)₂.6H₂O and 1.63 g benzimidazole (Hbim). The resultant solution was stirred at room temperature for 48 hours. After that, the product was collected by centrifugation and then washed with DMF [16]. After washing and second centrifugation, the particles were re-dispersed in fresh DMF before use.

To prepare the membrane casting solution, PBI was first dissolved in N-Methyl-2-pyrrolidone (NMP) by stirring it for 48 hours at 120° C., followed by cooling down to room temperature and then filtered using 1.0 um polytetrafluoroethylene (PTFE) membranes. The PBI solution was added to ZIF-7 nano particles which were separated by the third centrifugation from the suspension in DMF. The transparent ZIF-7/PBI suspension was stirred and sonicated alternatively for 24 hours to break the clusters formed due to the weak interaction between particles, and let the particles disperse more homogeneously. The polymer concentration in the solvent was 2 wt % while the ZIF-7 loading varied from 10 to 50 wt %. The solutions were then ring casted onto silica wafers and dried in a vacuum oven at 75° C. for 12 hours. After nature cooled down, the membranes were peeled off from the silica wafers and further dried in a vacuum oven at 200° C. for 1 day. The heating and cooling rate of the oven was both 20° C./h. To remove the residue solvent in the ZIF-7 pores, the membranes were solvent-exchanged with methanol for 12 h and dried in vacuum at 120° C. overnight.

The yield of ZIF-7 during the synthesis was about 40%. The accurate ZIF-7 loading can be determined from the amount of remained zinc oxide in the Thermo Gravimetric Analysis (TGA) analysis under air atmosphere according to the stoichiometry relationship.

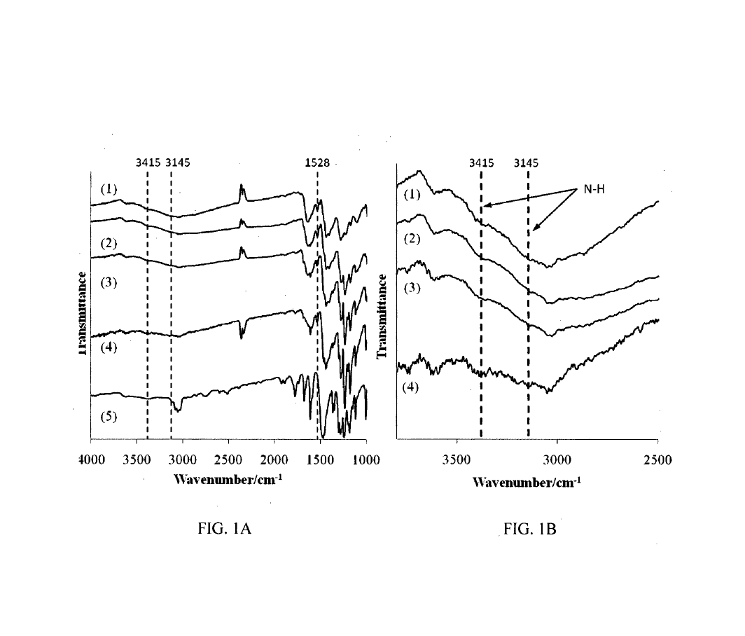

The chemistry of mixed-matrix composite membranes with different ZIF-7/PBI weight ratios are examined by Fourier transform infrared spectroscopy (FTIR) technique and the results of FTIR are shown in FIGS. 1A and 1B, (1) pure PBI; (2) 10/90 (w/w) ZIF-7/PBI; (3) 25/75 (w/w) ZIF-7/PBI; (4) 50/50 (w/w) ZIF-7/PBI; (5) ZIF-7 powder. FIG. 1A shows spectra in the original range and FIG. 1B shows spectra at the N—H region.

All the spectra of membranes with PBI fraction are normalized by the peak at 1528 cm⁻¹, which is assigned to the in-plane ring vibration of 2-substituted benzimidazole [17]. It is shown that with the increasing of ZIF-7 nano particle loadings, the peaks of N—H bond (3415 cm⁻¹ for ‘free’ non-hydrogen-bonded N—H stretching, and 3145 cm⁻¹ for self-associated N—H stretching) become weaker. This result indicates that there is a strong interaction between PBI and ZIF-7 nano particles in which the reactive hydrogen atom is replaced by the zinc ion on the surface of ZIF-7, forming a sub-nano interphase structure between ZIF-7 and PBI as a fine extension of ZIF-7 frameworks. The N—H group is also observed in the spectrum of ZIF-7 powder as shown in FIG. 1A. This is a result of special surface due to the synthesis environment with excess benzimidazole (bim), which can act both as a linker in its deprotonated form and as a terminating and stabilizing unit in its neutral form [18]. The benzimidazole is deprotonated when it acts as a linker, so that there is no N—H in this type of benzimidazole. On the other hand, when it acts as a terminating unit, the N—H in benzimidazole is available, and cannot been linked with another Zinc ion. In synthesis environment with excess benzimidazole (bim), the Zinc ion that can be reacted with bim is not enough, so that benzimidazole with N—H group will remained on the surface of ZIF particles as a terminating and stabilizing unit.

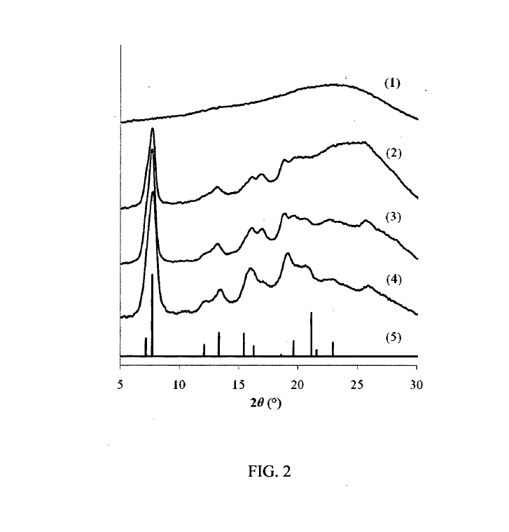

Wide-angle X-ray diffraction (WAXRD) measurements between 2° to 30° were conducted to determine the crystalline structure in each nano-composite membrane. The XRD patterns are shown in FIG. 2: (1) pure PBI; (2) 10/90 (w/w) ZIF-7/PBI; (3) 25/75 (w/w) ZIF-7/PBI; (4) 50/50 (w/w) ZIF-7/PBI; (5) ZIF-7 (theoretical). The patterns of pure PBI and ZIF-7 are included in FIG. 1 for comparison purpose. The XRD pattern of pure PBI shows a broad peak from 10 to 26 Å, which is a characteristic of amorphous structure and consistent with the reported XRD pattern for PBI in the literature [19]. The diffraction patterns of the ZIF-7/PBI mixed-matrix composite membranes exhibit intense, characteristic ZIF-7 crystalline peaks matching well with pure ZIF-7 and PBI patterns. This result shows that ZIF-7 and PBI structures are present in the membrane. Meanwhile, the peak value of patterns represent to amorphous PBI shifted to lower value of 2θ, indicating enlargement of d-spacing between PBI chains. Besides, a new peak with 2θ value of 25.5° is observed in the spectra of all ZIF-7/PBI nano-composite membranes. These two changes may indicate that a new kind of PBI-ZIF-7 interphase structure was formed with PBI chains attached and refolded onto the surface of ZIF-7. In this structure, the attached PBI chains may become more rigid as a result of strong interaction with ZIF-7. The refolding of the dense packed PBI chains may introduce larger and greater amount of free volume in the membrane for gas permeation.

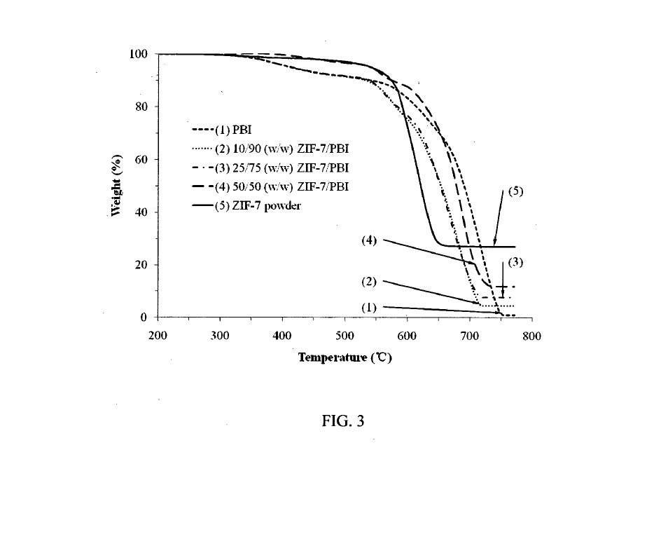

Thermo gravimetric analysis (TGA) was applied to study the thermo stability of PBI/ZIF-7 mixed-matrix composite membranes. See FIG. 3: (1) pure PBI; (2) 10/90 (w/w) ZIF-7/PBI; (3) 25/75 (w/w) ZIF-7/PBI; (4) 50/50 (w/w) ZIF-7/PBI; (5) ZIF-7 powder. The results were calculated using the weight at 200° C. as the starting point (FIG. 3) because PBI is likely to absorb water and exhibit weight loss at lower temperature far below the starting point of its thermo decomposition [20]. From 350° C. to 450° C., there is a weight loss of less than 10% in pure PBI spectra, which may represent additives or impurities in commercial polymer powders, as reported by Jaffe et al. [20]. It is shown that PBI, ZIF-7 and mixed-matrix composite membranes all exhibit excellent thermo stability up to 550° C. in air. After heating up to 710° C. at atmosphere in air, PBI is completely decomposed and remaining only zinc oxide, a derivative of zinc based ZIFs [18].

The pure and mixed gas permeabilities of H₂ and CO₂ through the pure PBI and ZIF-7/PBI mixed-matrix composite membranes with different ZIF-7/PBI weight ratios under 35° C. are shown in Table 1. For the mixed-matrix composite membranes, the gas permeability of H₂ exhibits significant enhancement with increasing ZIF-7 loadings, from 3.7 Barrer of pure PBI to 26.2 Barrer of 50/50 (w/w) ZIF-7/PBI. Meanwhile, the mixed-matrix composite membrane selectivity improves from 8.6 to 14.9 Barrer.

TABLE 1
Pure gas and mixed gas permeation properties of pure PBI and
ZIF-7/PBI mixed-matrix composite membranes with different
ZIF-7/PBI weight ratios at 35° C.

| | Single gas | | | Mixed gas | | |
|---|---|---|---|---|---|---|
| | permeability^{a} | | Ideal | permeability^{c} | | Separation |
| | (Barrer^{b}) | | selectivity | (Barrer) | | factor |
| Membrane name | H₂ | CO₂ | H₂/CO₂ | H₂ | CO₂ | H₂/CO₂ |
| PBI | 3.7 | 0.4 | 8.7 | 2.9 | 0.3 | 7.1 |
| 10/90 (w/w) | 7.7 | 0.6 | 12.9 | — | — | — |
| ZIF-7/PBI | | | | | | |
| 25/75 (w/w) | 15.4 | 1.3 | 11.9 | 6.3 | 0.9 | 6.8 |
| ZIF-7/PBI | | | | | | |
| 50/50 (w/w) | 26.2 | 1.8 | 14.9 | 13.3 | 1.8 | 7.2 |
| ZIF-7/PBI | | | | | | |

^{a}Single gas tests were performed in 3.5 atm, at 35° C.
^{b}1 Barrer = 10⁻¹⁰ cm³O₂ cm/cm²scmHg.
^{c}Mixed gas tests were performed in 7 atm with 50% H₂ and 50% CO₂, at 35° C.

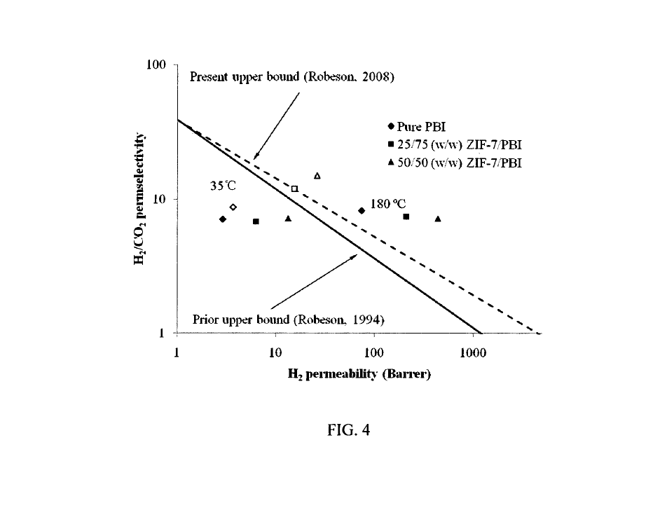

For possible application in synthetic gas separation, gas mixture tests from 35° C. to 180° C. were conducted using pure PBI and mixed-matrix composite membranes with ZIF-7/PBI ratios 25/75 and 50/50, respectively. The permeability test used was described by Lin et al. [24]. The results are shown in FIG. 4. The results were compared with Robeson upper bound [21] as well. It is observed that the pure H₂ permeability and ideal selectivity at 35° C. of 50/50 (w/w) ZIF-7/PBI has passed though the upper bound. Although the mixed gas separation performance at 35° C. dropped, a remarkable improvement is observed when the membranes are tested at 180° C.

### Example 2

### Synthesis of ZIF-8/poly-2,2′-(m-phenylene)-5,5′ bibenzimidazole

The ZIF-8/PBI was obtained as described in Example 1.

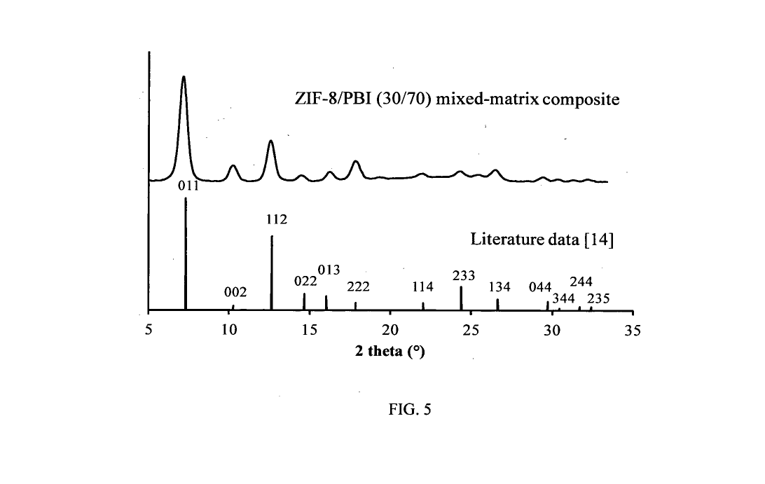

FIG. 5 shows and compares the XRD patterns between 5° to 35° from the 30/70 ZIF-8/PBI flat-sheet membrane and the data from literature [14]. They match extremely well and confirm the successful synthesis of ZIF-8 and its crystalline structure remains the same after incorporating into the PBI matrix.

The outer layer dope composition was chosen as 24 wt % PBI in DMAc. The ZIF-8 nano-particles were added according to the targeted weight ratios to the PBI polymer. For the preparation of the outer-layer spinning dope, the as-synthesized ZIF-8 particles were firstly added into a certain amount of PBI/DMAc dope with continuous stirring, followed by topping up the dope with DMAc to the targeted composition. The solutions were stirred at room temperature for 24 hours to ensure the homogeneous dispersion of nano-particles in the dope. The inner layer spinning dope was a mixture of 21.6 wt % Matrimid and 78.4 wt % DMAc. For the preparation of the inner-layer spinning dope, Matrimid polymer powder was added gradually to DMAc under continuous agitation, and the solution was stirred for 24 hours to ensure complete dissolution of Matrimid. Both the outer layer dope and inner layer dope were left standing for another 24 hours for degassing before loading into the respective syringe pumps (ISCO 1000), followed by another degassing for overnight. The inner layer dope and outer layer dope were co-extruded together through a triple-orifice spinneret by a dry-jet/wet spinning process. The detailed description of the set up for dual-layer hollow fiber spinning and process can be found elsewhere [23], the teachings of which are incorporated by reference herein in their entirety.

Dual layer hollow fiber is fabricated by co-extrusion of outer layer dope and inner layer dope with different composition through a triple-orifice spinneret by a dry-jet/wet spinning process. Dual layer hollow fiber was employed for the following reasons: (1) PBI membranes are brittle when fabricated from the non-solvent phase-inversion process. This problem can be avoided by choosing a strong material as the inner layer during co-extrusion; (2) PBI has low gas permeability. By choosing an inner layer material with high permeability, the gas transport resistance of the support layer can be effectively reduced; (3) PBI/ZIF-8 is relatively expensive. By choosing a polymeric material as the supporting inner layer, the overall cost of hollow fibers can be significantly reduced. In addition, the de-lamination problem between the two layers can be eliminated because PBI and Matrimid are miscible.

TABLE 2
Pure gas permeation properties of ZIF-
8/PBI based dual-layer hollow fibers.

| Sample name | | PZM10-I E | PZM20-I E | PZM33-I E |
|---|---|---|---|---|
| Permeance | H₂ | 8.9 | 32.2 | 34.9 |
| (GPU) | CO₂ | 0.9 | 6.4 | 8.7 |
| Selectivity | | 9.5 | 5.0 | 4.0 |

1 GPU = 10⁻⁶ cm³ (STP) cm⁻² s⁻¹ cmHg⁻¹
Single gas tests were performed in 3.5 atm, at room temperature.
The number in the sample name means the weight percentage of ZIF-8 in the outer layer.
PZM = PBI-ZIF-8/Matrimid
I = solvent exchange process where M: methanol; I; IPA
E = spinning condition

### REFERENCES

1. P. Bernardo, et al., Membrane gas Separation: A review/state of the art, Industrial & Engineering Chemistry Research, 48 (2009) 4638-4663.
2. R. Baker, Future directions of membrane gas-separation technology, Membrane Technology, (2001) 5-10.
3. L. Shao, et al., Polymeric membranes for the hydrogen economy: Contemporary approaches and prospects for the future, Journal of Membrane Science, 327 (2009) 18-31.
4. H. Vogel, et al., Polybenzimidazoles, new thermally stable polymers, J. Polym. Sci., 50 (1961) 511-539.
5. Y. Tsur, et al., Effects of structure on properties of some new aromatic-aliphatic polybenzimidazoles, J Polym Sci Part A—Polym Chem, 12 (1974) 1515-1529.
6. D. R. Pesiri, et al., Thermal optimization of polybenzimidazole meniscus membranes for the separation of hydrogen, methane, and carbon dioxide, Journal of Membrane Science, 218 (2003) 11-18.
7. K. A. Berchtold, et al., presented at Fifth Annual Conference on Carbon Capture & Sequestration, Alexandria, May 2006.
8. S. S. Hosseini, et al., Gas separation membranes developed through integration of polymer blending and dual-layer hollow fiber spinning process for hydrogen and natural gas enrichments, Journal of Membrane Science, 349 (2010) 156-166.
9. M. D. Jia, et al., Molecular-sieving effect of the zeolite-filled silicone-rubber membranes in gas separation, Journal of Membrane Science, 57 (1991) 289-296.
10. L. Shao, et al., Crosslinking and stabilization of nanoparticle filled PMP nanocomposite membranes for gas separations, Journal of Membrane Science, 326 (2009) 285-292.
11. C. M. Zimmerman, et al., Tailoring mixed matrix composite membranes for gas separations, Journal of Membrane Science, 137 (1997) 145-154
12. S. Kulprathipanja, et al., Separation of fluids by means of mixed matrix membranes, U.S. Pat. No. 4,740,219, (1988).
13. T. S. Chung, et al., Mixed matrix membranes (MMMs) comprising organic polymers with dispersed inorganic fillers for gas separation, Progress in Polymer Science, 32 (2007) 483-507.
14. K. S. Park, et al., Exceptional chemical and thermal stability of zeolitic imidazolate frameworks, Proceedings of the National Academy of Sciences of the United States of America, 103 (2006) 10186-10191.
15. M. C. McCarthy, et al., Synthesis of zeolitic imidazolate framework films and membranes with controlled microstructures, Langmuir, 26 (2010) 14636-14641.
16. Y. S. Li, et al., Molecular sieve membrane: Supported metal-organic framework with high hydrogen selectivity, Angewandte Chemie —International Edition, 49 (2010) 548-551.
17. Z. H. Chang, et al., Chemical oxidative degradation of polybenzimidazole in simulated environment of fuel cells, Polymer Degradation and Stability, 94 (2009) 1206-1212.
18. J. Cravillon, et al., Rapid room-temperature synthesis and characterization of nanocrystals of a prototypical zeolitic imidazolate framework, Chemistry of Materials, 21 (2009) 1410-1412.
19. M. Sadeghi, et al., Enhancement of the gas separation properties of polybenzimidazole (PBI) membrane by incorporation of silica nano particles, Journal of Membrane Science, 331 (2009) 21-30.
20. M. Jaffe, et al., Thermal characterization of high-performance PBI and 6F polymers and their alloys, Polymer Engineering and Science, 32 (1992) 1236-1241.
21. L. M. Robeson, The upper bound revisited, Journal of Membrane Science, 320 (2008) 390-400.
22. L. M. Robeson, et al., High performance polymers for membrane separation, Polymer, 35 (1994) 4970.
23. D. F. Li, et al., J. Membr. Sci. 198 (2002) 211.
24. W. H. Lin, et al., Gas transport properties of 6FDA-durene/1,4-phenylenediamine (pPDA) copolyimides, J. Polym. Sci. Pt. B-Polym. Phys., 38 (2000) 2703-2713.

All references are incorporated by reference herein in their entirety.

While this invention has been particularly shown and described with references to example embodiments thereof, it will be understood by those skilled in the art that various changes in form and details may be made therein without departing from the scope of the invention encompassed by the appended claims.

1. A mixed-matrix composite material comprising a continuous phase and zeolitic imidazolate framework (ZIF) particles dispersed in the continuous phase, wherein the continuous phase is polybenzimidazole.

2. The mixed-matrix composite material of claim 1, wherein the ZIF particles are formed by:
a) mixing a transition metal source and an imidazolate compound in a solvent for a sufficient amount of time to allow the transition metal to link to the imidazolate compound, thereby forming a suspension comprising zeolitic imidazolate framework (ZIF) particles; and
b) collecting and washing the ZIF particles formed in step a) with a solvent suitable to wet the ZIF particles.

3. The mixed-matrix composite material of claim 1, wherein the ZIF particles comprise metal building units and an imidazolate compound linking metal building units adjacent thereto.

4. The mixed-matrix composite material of claim 3, wherein the metal building units are transition metals selected from zinc (Zn), cobalt (Co), cadmium (Cd), indium (In), iron (Fe), copper (Cu) and combinations thereof.

5. The mixed-matrix composite material of claim 3, wherein the imidazolate compound linking adjacent metal building units of ZIFs is selected from:

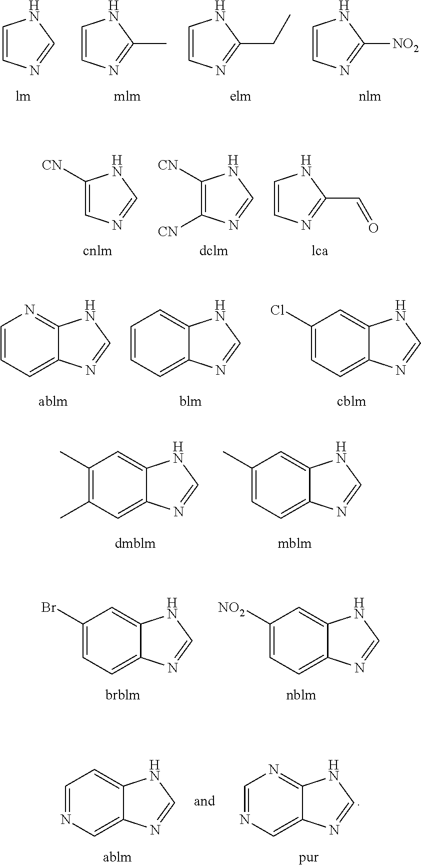

6. The mixed-matrix composite material of claim 1, wherein the polybenzimidazole comprises one or more polymers selected from: 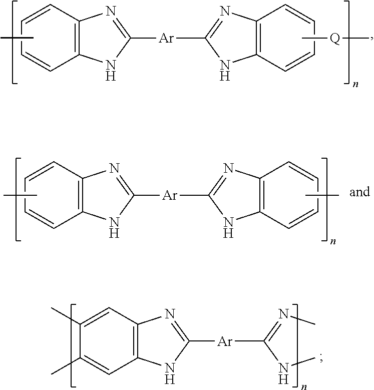
wherein
Ar is an aromatic group selected from a substituted or unsubstituted divalent C6 to C24 arylene group and a substituted or unsubstituted divalent C4 to C24 heterocyclic group;
where the aromatic group is present singularly, at least two aromatic groups are fused to form a condensed cycle, or at least two aromatic groups are linked by a single bond or a functional group selected from O, S, C(═O), CH(OH), S(═O)₂, Si(CH₃)₂, (CH₂)ₚ, (CF₂)_{q}, C(CH₃)₂, C(CF₃)₂ and C(═O)NH;
p is 1-10;
q is 1-10;
Q is O, S, C(═O), CH(OH), S(═O)₂, Si(CH₃)₂, (CH₂)ₚ, (CF₂)_{q}, C(CH₃)₂, C(CF₃)₂, C(═O)NH, C(CH₃)(CF₃), or a substituted or unsubstituted phenylene group, wherein the substituted phenylene group is a phenylene group substituted with a C1 to C6 alkyl group or a C1 to C6 haloalkyl group; and further wherein Q is linked with aromatic groups with meta-meta,
meta-para, para-meta, or para-para positions; and
n is an integer ranging from 10 to 2000.

7. The mixed-matrix composite material of claim 6, wherein the one or more polymers is selected from:
poly-2,2′-(m-phenylene)-5,5′-bibenzimidazole;
poly-2,2′-(pyridylene-3″,5″)-5,5′-bibenzimidazole;
poly-2,2′-(furylene-2″,5″)-5,5′-bibenzimidazole;
poly-2,2-(naphthalene-1″,6″)-5,5′-bibenzimidazole;
poly-2,2′-(biphenylene-4″,4″)-5,5′-bibenzimidazole;
poly-2,2′-amylene-5,5′-bibenzimidazole;
poly-2,2′-octamethylene-5,5′-bibenzimidazole;
poly-2,6-(m-phenylene)-diimidazobenzene;
poly-2,2′-cyclohexenyl-5,5′-bibenzimidazole;
poly-2,2′-(m-phenylene)-5,5′di(benzimidazole)ether;
poly-2,2′-(m-phenylene)-5,5′-di(benzimidazole)sulfide;
poly-2,2′-(m-phenylene)-5,5′-di(benzimidazole)sulfone;
poly-2,2′-(m-phenylene)-5,5′-di(benzimidazole)methane;
poly-2′-2″-(m-phenylene)-5′,5″-(di(benzimidazole)propane-2,2; and
poly-2′,2″-(m-phenylene)-5′,5″-di(benzimidazole)ethylene-1,2; and further wherein the double bonds of the ethylene are intact in the final polymer.

8. The mixed-matrix composite material of claim 7, wherein the mixed-matrix composite material is represented by Formula (I): 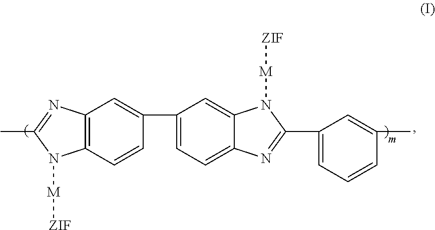
wherein
M is zinc (Zn), cobalt (Co), cadmium (Cd), indium (In), iron (Fe), copper (Cu) or combination thereof; and
m is an integer ranging from 10 to 2000.

9. The mixed-matrix composite material of claim 8, wherein the ZIF particles are Zn(bIm)₂ or Zn(mIm)₂.

10. The mixed-matrix composite material of claim 1, wherein the mixed-matrix composite material is in the configuration of a flat symmetric sheet, flat asymmetric sheet, coating layer or hollow fiber.

11. A process of forming a mixed-matrix composite material, comprising:
a) providing a polybenzimidazole solution; and
b) mixing zeolitic imidazolate framework (ZIF) particles into the polybenzimidazole solution for a sufficient amount of time to allow the ZIF particles to uniformly disperse in the polybenzimidazole solution; and
c) fabricating the solution to thereby produce the mixed-matrix composite material comprising a continuous phase of polybenzimidazole and ZIF particles dispersed in the continuous phase.

12. The process of claim 11, wherein the ZIF particles are formed by:
a) mixing a transition metal source and an imidazolate compound in a solvent for a sufficient amount of time to allow the transition metal to link to the imidazolate compound, thereby forming a suspension comprising zeolitic imidazolate framework (ZIF) particles; and
b) collecting and washing the ZIF particles formed in step a) with a solvent suitable to wet the ZIF particles.

13. The process of claim 11, wherein the ZIF particles comprise metal building units and an imidazolate compound linking metal building units adjacent there to.

14. The process of claim 13, wherein the metal building units are transition metals selected from zinc (Zn), cobalt (Co), cadmium (Cd), indium (In), iron (Fe), copper (Cu) and combinations thereof.

15. The process of claim 11, wherein the imidazolate compound is selected from:

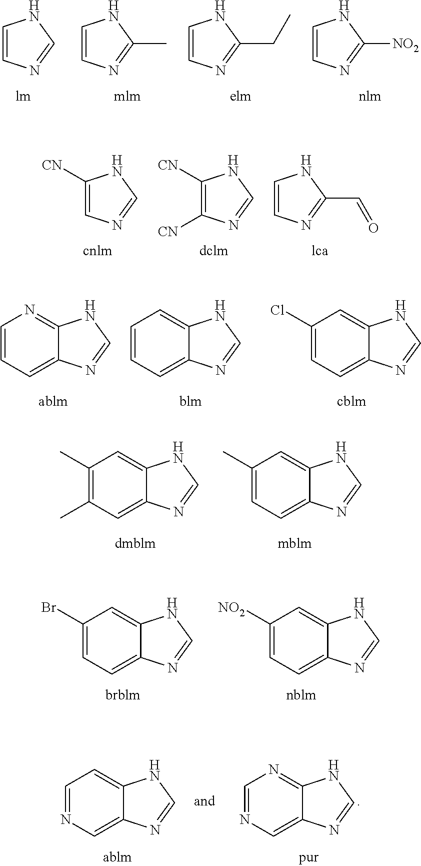

16. The process of claim 11, wherein the polybenzimidazole comprises one or more polymers selected from: 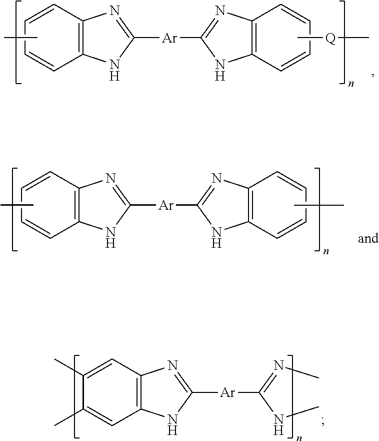
wherein,
Ar is an aromatic group selected from a substituted or unsubstituted divalent C6 to C24 arylene group and a substituted or unsubstituted divalent C4 to C24 heterocyclic group;
where the aromatic group is present singularly, at least two aromatic groups are fused to form a condensed cycle, or at least two aromatic groups are linked by a single bond or a functional group selected from O, S, C(═O), CH(OH), S(═O)₂, Si(CH₃)₂, (CH₂)ₚ, (CF₂)_{q}, C(CH₃)₂, C(CF₃)₂ and C(═O)NH;
p is 1-10;
q is 1-10;
Q is O, S, C(═O), CH(OH), S(═O)₂, Si(CH₃)₂, (CH₂)ₚ, (CF₂)_{q}, C(CH₃)₂, C(CF₃)₂, C(═O)NH, C(CH₃)(CF₃), or a substituted or unsubstituted phenylene group, wherein the substituted phenylene group is a phenylene group substituted with a C1 to C6 alkyl group or a C1 to C6 haloalkyl group; and further wherein Q is linked with aromatic groups with meta-meta,
meta-para, para-meta, or para-para positions; and
n is an integer ranging from 10 to 2000.

17. The process of claim 16, wherein the one or more polymers is selected from:
poly-2,2′-(m-phenylene)-5,5′-bibenzimidazole;
poly-2,2′-(pyridylene-3″,5″)-5,5′-bibenzimidazole;
poly-2,2′-(furylene-2″,5″)-5,5′-bibenzimidazole;
poly-2,2-(naphthalene-1″,6″)-5,5′-bibenzimidazole;
poly-2,2′-(biphenylene-4″,4″)-5,5′-bibenzimidazole;
poly-2,2′-amylene-5,5′-bibenzimidazole;
poly-2,2′-octamethylene-5,5′-bibenzimidazole;
poly-2,6-(m-phenylene)-diimidazobenzene;
poly-2,2′-cyclohexenyl-5,5′-bibenzimidazole;
poly-2,2′-(m-phenylene)-5,5′di(benzimidazole)ether;
poly-2,2′-(m-phenylene)-5,5′-di(benzimidazole)sulfide;
poly-2,2′-(m-phenylene)-5,5′-di(benzimidazole)sulfone;
poly-2,2′-(m-phenylene)-5,5′-di(benzimidazole)methane;
poly-2′-2″-(m-phenylene)-5′,5″-(di(benzimidazole)propane-2,2; and
poly-2′,2″-(m-phenylene)-5′,5″-di(benzimidazole)ethylene-1,2; and further wherein the double bonds of the ethylene are intact in the final polymer.

18. The process of claim 17, wherein the mixed-matrix composite material is represented by Formula (I): 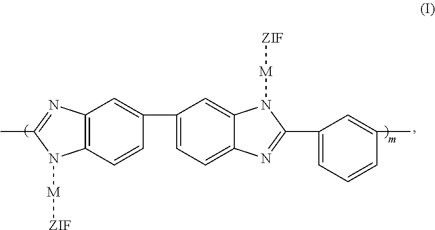
wherein
M is zinc (Zn), cobalt (Co), cadmium (Cd), indium (In), iron (Fe), copper (Cu) or combination thereof; and
m is an integer ranging from 10 to 2000.

19. The process of claim 18, wherein the wherein the ZIF particles are Zn(bIm)₂ or Zn(mIm)₂.

20. A process for separating at least one gas or vapor from a mixture of gases or vapors, comprising:
a) providing a mixed-matrix composite material of claim 1; and
b) bringing a mixture of gases or vapors under pressure into contact with the mixed-matrix composite material of step a), whereby one of the gases and vapor permeates the membrane preferentially with respect to at least one other gas or vapor in the mixture of gases or vapors; thereby separating the gas or the vapor from the mixture.
